(19) United States
(12) Patent Application Publication
(10) Pub. No.: US 2026/0175149 A1
(43) Pub. Date: Jun. 25, 2026

(54) ADVANCED FUEL FILTRATION SYSTEM WITH INTERLOCKING CARTRIDGE SEAL DESIGN

(71) Applicant: ATMUS FILTRATION INC., Nashville, TN (US)

(72) Inventors: Connor David Oren, Columbus, IN (US); Zemin Jiang, Cookeville, TN (US); Jayant Singh, Pune (IN); Vaibhav Pimpalte, Pune (IN); Chetan Ghagre, Wardha (IN); Bharati Pundalik Dalavi, Ambernath (IN); Sagar Padale, Pune (IN); Sunny Nabhiraj Masutage, Miraj, IN (US); Joshua Luther Young, Livingston, TN (US)

(73) Assignee: ATMUS FILTRATION INC., Nashville, TN (US)

(21) Appl. No.: 19/539,797

(22) Filed: Feb. 13, 2026

Related U.S. Application Data
(63) Continuation of application No. 17/883,163, filed on Aug. 8, 2022, now Pat. No. 12,576,348.
Application No. 17/883,163 is a continuation of application No. PCT/US2021/017197, filed on Feb. 9, 2021.

(30) Foreign Application Priority Data
Feb. 11, 2020 (IN) 202041005898

(51) Int. Cl. B01D 29/21; B01D 29/58; B01D 35/16; B01D 36/00

(52) U.S. Cl. CPC B01D 29/21; B01D 29/58; B01D 35/16; B01D 36/003; B01D 2201/0423; B01D 2201/298; B01D 2201/301; B01D 2201/347

(57) ABSTRACT

A filter assembly includes a filter element and a filter housing. The filter housing includes a shell defining an inner cavity, and a lid configured to engage the shell at an opening of the inner cavity. The filter element is disposed within the inner cavity and includes a media pack, a first endplate, and a sealing member. The first endplate is sealingly engaged with a media pack first end and includes a skirt extending along a longitudinal axis of the media pack from the first end toward the second end. The sealing member is coupled to the skirt and is positioned between and forms a seal between the lid and the shell.

### CROSS-REFERENCE TO RELATED PATENT APPLICATIONS

The present application is a continuation of U.S. application Ser. No. 17/883,163, filed Aug. 8, 2022, which is a continuation of PCT Application No. PCT/US2021/017197, filed Feb. 9, 2021, which claims the benefit of and priority to Indian Provisional Patent Application No. 202041005898, filed Feb. 11, 2020. The contents of these applications are incorporated by reference in their entireties.

### TECHNICAL FIELD

The present disclosure relates generally to filters for use with internal combustion engine systems.

### BACKGROUND

Internal combustion engine systems require fuel (e.g., diesel fuel, gasoline, etc.) to operate. The fuel may be contaminated with water and/or particulate matter, which may damage various parts of the engine system if not removed from the fluid. To remove water and other contaminants, the fuel is generally passed through a filter assembly, which may include a particulate filter and/or fuel-water separator.

### SUMMARY

One embodiment of the present disclosure relates to a filter assembly including a filter element and a filter housing. The filter housing includes a shell defining an inner cavity, and a lid configured to engage the shell at an opening of the inner cavity. The filter element is disposed within the inner cavity and includes a media pack having a media pack first end and a media pack second end, a first endplate, and a sealing member. The first endplate is sealingly engaged with the media pack first end and includes a skirt extending along a longitudinal axis of the media pack from the media pack first end toward the media pack second end. The sealing member is coupled to the skirt and is positioned between and forms a seal between the lid and the shell. The filter element may include a plurality of media packs. For example, the filter element may include an outer media pack defining a central cavity, and an inner media pack disposed within the central cavity.

Another embodiment of the present disclosure relates to a filter element. The filter element includes a media pack having a media pack first end and a media pack second end, a first endplate, and a sealing member. The first endplate is sealingly engaged with a first end of the filter element and includes a skirt extending along a longitudinal axis of the media pack from the media pack first end toward the media pack second end. The sealing member is coupled to the skirt and circumferentially surrounds the media pack. The sealing member protrudes beyond an outer perimeter of the first endplate. The filter element may include a plurality of media packs. For example, the filter element may include an outer media pack defining a central cavity, and an inner media pack disposed within the central cavity.

Still another embodiment of the present disclosure relates to a filter assembly. The filter assembly includes a filter housing and a filter element. The filter housing includes a shell defining an inner cavity, a lid configured to engage the shell at an opening of the inner cavity, and a drain valve that fluidly couples the inner cavity to an environment surrounding the shell. The filter element is disposed within the inner cavity. The filter element includes an outer media pack defining a central cavity, an inner media pack disposed within the central cavity, and an endplate sealingly engaged with both the outer media pack and the inner media pack. The endplate defines an opening that is positioned between the inner media pack and the outer media pack. The opening is fluidly coupled to the drain valve.

Yet another embodiment of the present disclosure relates to a filter assembly. The filter assembly includes a first stage filter media pack, and a second stage filter media pack downstream from the first stage filter media pack. The second stage filter media pack includes a coalescing pleated media and a stripping media.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a side cross-sectional view of a filter assembly, according to an embodiment.

FIG. 2 is another side cross-sectional view of the filter assembly of FIG. 1.

FIG. 3 is a perspective view of the filter assembly of FIG. 1.

FIG. 4 is a side view of the filter assembly of FIG. 1.

FIG. 5 is another side view of the filter assembly of FIG. 1.

FIG. 6 is a side cross-sectional view of the filter assembly of FIG. 1.

FIG. 7 is a side cross-sectional view of an upper sealing interface portion of the filter assembly of FIG. 1.

FIG. 8 is a side cross-sectional view of a lower sealing interface portion of the filter assembly of FIG. 1.

FIG. 9 is a schematic diagram of a filtration system, according to an embodiment.

FIG. 10 is a side cross-sectional view of a two stage filter assembly, according to an embodiment.

FIG. 11 is another side cross-sectional view of the two stage filter assembly of FIG. 10.

FIG. 12 is a side cross-sectional view of an inlet conduit portion of the two stage filter assembly of FIG. 10.

FIG. 13 is a side cross-sectional view of a first stage portion of the two stage filter assembly of FIG. 10.

FIG. 14 is a side cross-sectional view of a second stage portion of the two stage filter assembly of FIG. 10.

FIG. 15 is a top view of a first stage portion of the two stage filter assembly of FIG. 10.

FIG. 16 is a side cross-sectional view of a first filter element of the two stage filter assembly of FIG. 10.

FIG. 17 is a side cross-sectional view of a second filter element of the two stage filter assembly of FIG. 10.

FIG. 18 is a perspective view of a two stage filter assembly, according to another embodiment.

FIG. 19 is a bottom perspective view of a portion of the two stage filter assembly of FIG. 18.

FIG. 20 is a front side view of the two stage filter assembly of FIG. 18.

FIG. 21 is a rear side view of the two stage filter assembly of FIG. 18.

FIG. 22 is a side cross-sectional view of the two stage filter assembly of FIG. 18.

FIG. 23 is a side cross-sectional view of a first filter element of the two stage filter assembly of FIG. 18.

FIG. 24 is perspective view of an endplate portion of the first filter element of FIG. 23.

FIG. 25 is a side cross-sectional view of a second filter element of the two stage filter assembly of FIG. 18.

FIG. 26 is a perspective view of an endplate portion of the second filter element of FIG. 25.

FIG. 27 is a bottom perspective view of an outlet conduit portion of the two-stage filter assembly of FIG. 18.

FIG. 28 is a perspective view of a standpipe of the two-stage filter assembly of FIG. 18.

FIG. 29 is another side cross-sectional view of the two stage filter assembly of FIG. 18.

FIG. 30 is another side cross-sectional view of the two stage filter assembly of FIG. 18.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to diesel fuel filtration systems. The various concepts introduced above and discussed in greater detail below may be implemented in any of numerous ways, as the described concepts are not limited to any particular manner of implementation. Examples of specific implementations and applications are provided primarily for illustrative purposes.

### I. Overview

Internal combustion engine systems require a clean source of fluids (e.g., fuel, oil, etc.) to power and lubricate the engine. Unfiltered fluids may include dirt, metal particles, and other solid contaminants that can damage engine components (e.g., fuel injectors, cylinder rings, pistons, etc.). In order to protect the engine components, the internal combustion engine systems may include a filtration system, which filters incoming and/or recirculating fluids to remove any solid materials before passing the fluids to the engine. In some instances, the filtration system includes a filter housing and a replaceable filter cartridge, which may be periodically replaced by an operator and/or technician to maintain the differential pressure across the filtration system to within reasonable levels.

A replaceable filter cartridge may include various components to facilitate engagement and sealing of the filter cartridge within a filter housing. For example, the filter cartridge may include an gasket (such as an O-ring) or another form of sealing member that engages with the housing to prevent fluid bypass between the clean and dirty sides of the filter cartridge. The filtration system also includes a sealing member between the lid and body of the housing that prevents fluid leakage into an environment surrounding the filtration system (e.g., the engine compartment, etc.). The design of this sealing interface, between the lid and body of the housing, affects the maximum fluid pressure that can be achieved through the filtration system before fluid leakage from the housing occurs.

Modern fuel injection systems typically require increased fuel supply pressures than previous generations. Additionally, the fuel cleanliness requirements in modern fuel injection systems may require multiple stages of fuel filtration to ensure more complete removal of water and particulate contamination from the fuel before the fuel reaches the engine. However, the use of multiple stages of filtration generally requires multiple independent fuel filter assemblies, which can increase the overall space envelope required by the fuel filtration system.

Referring to the figures generally, a fuel filtration system for a diesel engine system is shown. The fuel filtration system includes a replaceable filter element cartridge having a sealing interface designed to reduce the number of sealing members (e.g., O-rings, gaskets, etc.) used in the filtration system and increase the reliability and maximum operating pressure of the filtration system. The filter element includes a media pack and a first endplate that is sealingly engaged with the media pack. The first endplate includes a skirt that extends along a longitudinal axis of the media pack between opposing axial ends of the media pack. The filter element also includes a sealing member that provides sealing between both (i) the filter element and the filter housing, and (ii) the lid and shell (e.g., body, etc.) of the housing. The sealing member is coupled to the skirt and extends in a radial direction from the skirt toward the housing. The sealing member is “sandwiched” or otherwise disposed between the lid and the shell. In other words, the sealing member is secured in place by the compressive force between the lid and the shell, which increases the overall reliability of the sealing interface and the maximum allowable fuel pressure within the filter housing.

In at least one embodiment, the filter element includes multiple media packs including an outer media pack defining a central cavity and an inner media pack disposed within the central cavity. The inner media pack includes a stripping media to facilitate water separation from the incoming fuel. The filter element includes a second endplate that is sealingly engaged with both the outer media pack and the inner media pack. Among other benefits, the structure of the second endplate allows water separation to occur through the space between the outer media pack and the inner media pack. In particular, the second endplate defines an opening positioned between the inner media pack and the outer media pack to allow separated water to escape from between the inner and outer media packs to a drain valve disposed at a lower end of the filter housing.

In at least one embodiment, the fuel filtration system is a two stage fuel filtration system that includes two replaceable filter element cartridges. The fuel filtration system includes a single filter housing to receive the filter cartridges and thereby reduce the overall footprint of the fuel filtration system (as compared to conventional two stage filtration systems with multiple independent fuel filter housings). In at least one embodiment, the two stage fuel filtration system includes a first stage filter media pack and a second stage filter media pack disposed downstream from the first stage filter media pack. The second stage filter media pack includes a coalescing pleated media and a stripping media to enhance water separation from the incoming fuel.

### II. Example Fuel Filtration System

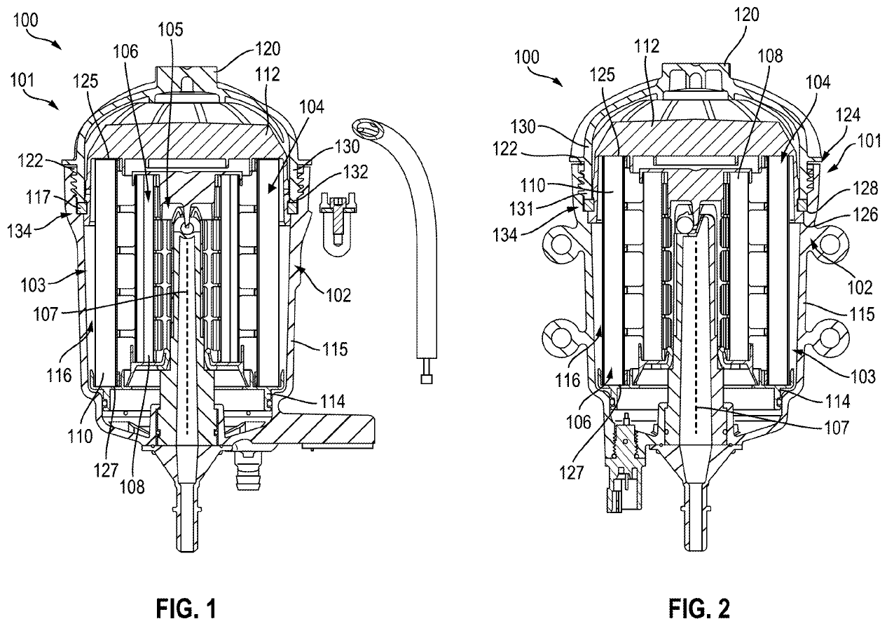

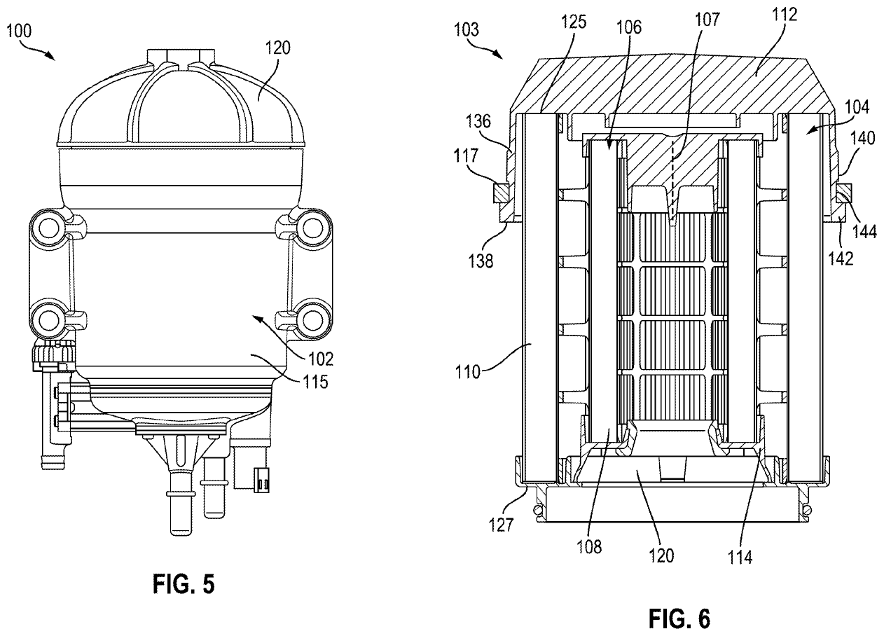

FIGS. 1-5 show a high pressure fluid filtration system, shown as filtration system 100, according to an embodiment. The filtration system 100 may be used to filter a fluid provided to an internal combustion engine. The fluid may be a fuel, an engine oil, a hydraulic oil, or another lubricant. In the example embodiment of FIGS. 1-5, the filtration system 100 is a fuel filtration system for a diesel engine that uses diesel fuel to drive the combustion process. The filtration system 100 is configured to be mounted on the diesel engine but may be mounted remotely from the diesel engine in various example embodiments. As shown in FIGS. 1-2, the filtration system 100 includes a filter assembly 101 that includes a filter housing 102 and a filter element assembly 103. The filter element assembly 103 includes an outer filter element 104 (e.g., cartridge, etc.) disposed within the filter housing 102, and an inner filter element 106 (e.g., a secondary filter element, secondary cartridge, etc.) surrounded by and/or nested within the outer filter element 104 (e.g., a filter in filter design). Each of the outer filter element 104 and the inner filter element 106 include a media pack, shown as inner media pack 108 and outer media pack 110 (e.g., pleated filtration media, etc.) arranged as a cylindrical tube that circumscribes a central cavity 105 having a longitudinal axis 107. The outer media pack 110 and the inner media pack 108 each include filter media structured to filter particulate matter and water from fuel flowing therethrough so as to produce filtered fluid (e.g., clean fluid). The filter media may include porous material having a predetermined pore size. The filter media may include a paper-based filter media, a fiber-based filter media, or the like. In an embodiment, at least one filter element (e.g., a stage 1 filter element, the outer filter element 104, a stage 2 filter element, the inner filter element 106) is a fuel-water separator containing coalescing pleated media and stripping media to achieve optimal water/particle removal and engine protection. At least one of the filter elements may include an integrated coalescing wrap and hydrophobic screen.

In the example embodiment of FIGS. 1-2, the outer filter element 104 and the inner filter element 106 are each arranged as an outside-in flow filter element having an outer dirty side and an inner clean side. Fluid to be filtered passes from the dirty side of the outer filter element 104 to an annular space in between the outer filter element 104 and the inner filter element 106, and from the annular space to the clean side of the inner filter element 106. In one embodiment, the outer filter element 104 and the inner filter element 106 are affixed to one another by at least one endplate, shown as first endplate 112 (e.g., first endcap, upper endplate, upper endcap, etc.) to form a unitary body. As shown in FIGS. 1-2, the outer filter element 104 and the inner filter element 106 are also affixed to one another by a second endplate 114 (e.g., lower endplate, etc.). The first endplate 112 and the second endplate 114 are coupled to opposing axial ends of a media pack for each of the outer filter element 104 and the inner filter element 106 (e.g., the outer media pack 110 and the inner media pack 108). In particular, the first endplate 112 of the filter element assembly 103 is sealingly engaged with an outer media pack first end 125 (e.g., a first axial end) of the outer media pack 110, and a second endplate 114 (e.g., bottom endplate) is sealingly engaged with an outer media pack second end 127 (e.g., a second axial end) of the outer media pack 110 opposite the outer media pack first end 125. The first endplate 112 and the second endplate 114 are also sealingly engaged with opposing axial ends of the inner media pack 108.

As shown in FIGS. 1-5, the filter housing 102 includes a shell 115, canister, and/or body defining an inner cavity 116 that is configured to receive the inner filter element 106 and the outer filter element 104 therein. As shown in FIGS. 1-2, the filter housing 102 also includes a lid 120 (e.g., spin-on lid, etc.), cover, and/or cap that is configured to engage with (e.g., threadably engage, etc.) the shell 115 at an opening 122 to the inner cavity 116. The filter housing 102 and the lid 120 may be made from the same or different materials. For example, the filter housing 102 may be made (e.g., cast or otherwise formed) from an aluminum material or another suitable material. The lid 120 may be made (e.g., injection molded or otherwise formed) from a plastic material or another suitable material.

As shown in FIG. 2, the shell 115 defines a cylindrical inner cavity, shown as inner cavity 116, with a substantially circular cross-section. An upper end 124 of the shell 115 defines the opening 122 to the inner cavity 116. The shell 115 includes a lower housing ledge 126 (e.g., shelf, step, etc.) positioned circumferentially about the upper end 124 of the shell 115 and extending radially into the inner cavity 116. The shell 115 also includes an upper housing ledge 128 disposed between the lower housing ledge 126 and a threaded portion of the shell 115 at the upper end 124. An upper surface of each one of the lower housing ledge 126 and the upper housing ledge 128 are arranged in a substantially perpendicular relative to the sidewall of the shell 115 (e.g., substantially horizontal as shown in FIG. 2).

The lid 120 includes a cup-shaped upper portion and a cylindrical axial sidewall, shown as axial sidewall 130, extending downwardly from the upper portion. As shown in FIGS. 1-2, a lower portion 132 (e.g., flange, threaded cylindrical extension, etc.) of the axial sidewall 130 is configured to be received within the inner cavity 116 when the lid 120 is installed onto the shell 115 and to threadably engage the shell 115.

In the embodiment shown in FIGS. 1-5, the inner cavity 116 is sealed from an environment surrounding the filter housing 102 by the lid 120, shell 115, and by an undulating interlocking seal mechanism, shown as interlocking seal mechanism 134, that is formed at least partially by the first endplate 112 at an interface between the replaceable filter element cartridge, the lid 120, and the shell 115. FIG. 6 shows the filter element assembly 103 from the filtration system 100 of FIGS. 1-5. As shown, the first endplate 112 of the filter element assembly 103 includes a skirt 136 extending radially away from an outer perimeter of the outer media pack first end 125 and axially (e.g., parallel to the longitudinal axis 107 of the outer media pack 110) from the outer media pack first end 125 toward the outer media pack second end 127. A lower end 138 of the skirt 136 is disposed at an intermediate position between the outer media pack first end 125 and the outer media pack second end 127. The first endplate 112 further includes a sealing member 117 (e.g., o-ring, gasket, etc.) coupled to the skirt 136 proximate to the lower end 138 of the skirt 136. The sealing member 117 protrudes outwardly (e.g., radially outwardly) away from an outer perimeter of the skirt 136.

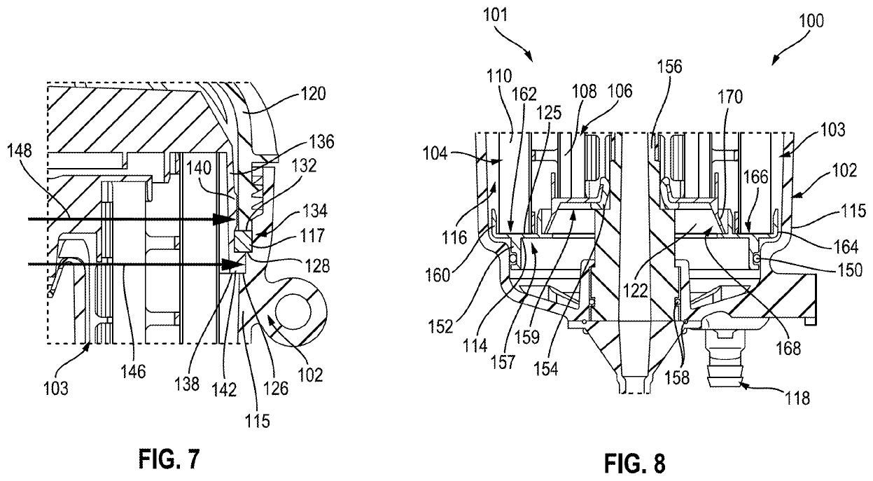

As shown in FIG. 6, the lower end 138 of skirt 136 is spaced radially apart from an outer perimeter of the outer media pack 110 such that the skirt 136 circumferentially surrounds the outer media pack first end 125 of the outer media pack 110. The lower end 138 of the skirt 136 includes a first protrusion 140 and a second protrusion 142 spaced axially apart from the first protrusion 140. The first protrusion 140 and the second protrusion 142 together define a recessed area 144 sized to receive the sealing member 117 therein. In at least one embodiment, the skirt 136 only includes one of the first protrusion 140 or the second protrusion 142 (e.g., only the second protrusion 142). As shown in FIG. 7, an outer radius 146 of the second protrusion 142 is greater than an outer radius 148 of the first protrusion 140, which helps support the sealing member 117 at the lower end 138 and prevents the sealing member 117 from being pulled down toward the open end of the skirt 136. The interaction between the second protrusion 142 and the shell 115 also prevents the sealing member 117 from becoming disconnected from the skirt 136 when the filter element assembly 103 is installed into the shell 115 as will be further described.

FIG. 7 shows the interlocking seal mechanism 134 of the filtration system 100 of FIGS. 1-5. As shown, the sealing member 117 is “sandwiched” or otherwise disposed or positioned between the lid 120 and the shell 115, forming a seal between the lid 120 and the shell 115, thereby preventing fuel from escaping the filter housing 102. An upper end (e.g., upper axial end surface) of the sealing member 117 is sealingly engaged with a lower surface of the lid 120, and a lower end (e.g., lower axial end surface) of the sealing member 117 (opposite the upper end) is sealingly engaged with the shell 115. More specifically, the lower end of the sealing member 117 is sealingly engaged with the upper housing ledge 128 of the shell 115. Among other benefits, the compressive force between the lid 120 and the shell 115 prevents movement of the sealing member 117 when the lid 120 is installed onto the shell 115, even under high fuel pressures and flow rates through the filter housing 102 (e.g., up to approximately 7 bar, 7.3 bar, or greater at flow rates of 4.0 L/min, 5.3 L/min, or greater).

As shown in FIG. 7, an upper surface of the second protrusion 142 is generally flush with an upper surface of the upper housing ledge 128 such that the lower end of the sealing member 117 is also sealingly engaged with the upper surfaces of both the second protrusion 142 and the upper housing ledge 128. An axial height of the second protrusion 142 is approximately the same as an axial spacing between the upper housing ledge 128 and the lower housing ledge 126. As such, a lower end of the second protrusion 142 (e.g., the lower end 138 of the skirt 136) is engaged with the lower housing ledge 126, which prevents over-insertion of the filter element assembly 103 into the filter housing 102 and helps center the filter element assembly 103 with respect to the filter housing 102. Engagement between the second protrusion 142 and the lower housing ledge 126 also prevents separation of the sealing member 117 from the skirt 136 when the filter element assembly 103 is installed into the filter housing 102 (e.g., due to the upward force applied to the sealing member 117 by the upper housing ledge 128). As shown in FIG. 7, the lower portion 132 of the axial sidewall 130 of the lid 120 is disposed at an intermediate radial position between the second protrusion 142 and the upper housing ledge 128, such that the sealing member 117 is compressed between (i) the lid 120 and (ii) both the second protrusion 142 and the upper housing ledge 128. Among other benefits, the interlocking seal mechanism 134 reduces the risk of fluid leakage from the inner cavity 116, and increases the maximum fluid pressure that can be maintained within the filter housing 102.

FIG. 8 shows a lower sealing interface between the filter element assembly 103 and the filter housing 102. The second endplate 114 includes a bottom section sealing member, shown as second sealing member 150 (e.g., o-ring, gasket, etc.), that separates the dirty and clean sides of the filter element assembly 103 at a lower end of the filter housing 102. In the embodiment of FIG. 8, the second endplate 114 separates the dirty and clean sides of the outer filter element 104. As shown, the second endplate 114 is shared between the outer filter element 104 and the inner filter element 106. The second sealing member 150 is coupled to the second endplate 114, to an axial sidewall 152 (e.g., cylindrical extension, etc.) that extends axially away from the outer filter element 104, and forms a radial seal between the second endplate 114 and an interior surface of the shell 115 (proximate a lower end of the inner cavity 116 opposite the opening 122 of the shell 115). In some embodiments, the second endplate 114 also includes a pressure bleed port, valve, etc. to prevent damage to the filter element assembly 103 due to high differential pressure (e.g., blockage of the media pack, etc.).

The second endplate 114 also includes a third sealing member 154 (e.g., o-ring, sump gasket sealing member, etc.) that separates the dirty and clean sides of the inner filter element 106. As shown in FIG. 8, the third sealing member 154 is coupled to the second endplate 114 proximate to an inner perimeter of the second endplate 114. The third sealing member 154 is disposed radially between the inner perimeter of the second endplate 114 and a standpipe 156 of the filter assembly 101, and sealingly engages the standpipe 156.

As shown in FIG. 8, the standpipe 156 forms part of a standpipe assembly that is configured to fluidly couple the clean side of the filter element assembly 103 to other components of the filtration system 100 and/or engine. The standpipe 156 is coupled to a lower end of the filter housing 102 and extends axially into the inner cavity 116. The standpipe assembly includes sealing members 158 (e.g., o-rings, gaskets, etc.) that sealingly engage with the filter housing 102 to prevent fluid leading from the inner cavity 116. As shown in FIG. 8, the sealing members 158 are disposed proximate to a lower end of the standpipe 156, radially between the standpipe 156 and the shell 115, and on a lower exterior wall of the shell 115.

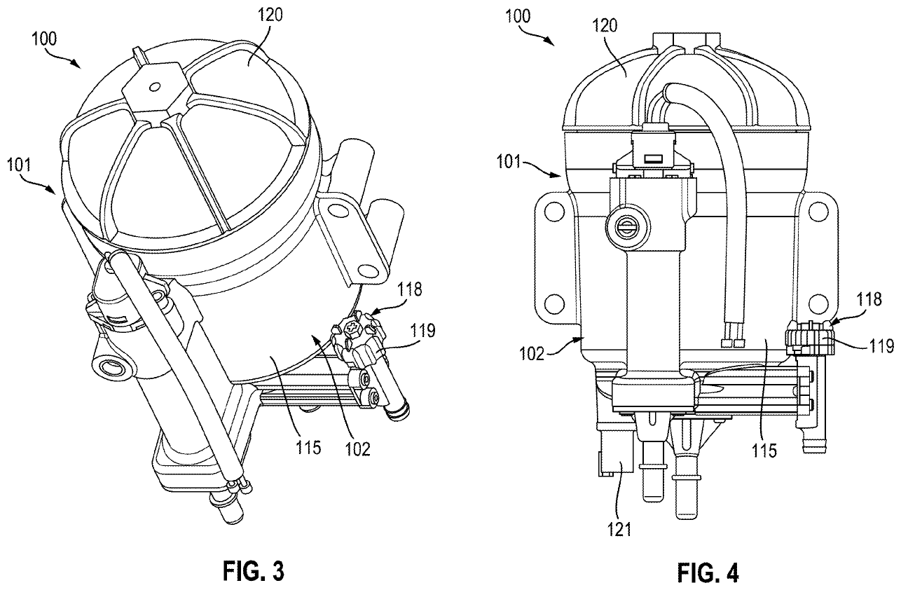

Returning to FIGS. 3-4, the filter assembly 101 may also include a drain valve assembly 118 including a drain valve 119 (e.g., a common integrated drain valve, solenoid valve, etc.) that allows for water to flow/drain from a first filtration stage (e.g., stage 1, outer filter element 104) and a second filtration stage (e.g., stage 2, inner filter element 106) while, simultaneously, allowing air to flow back in through the same port/bore. Among other benefits, this allows fluid to drain through the drain valve 119 under the force of gravity and in the absence of fuel pressure through the filter assembly 101. In at least one embodiment, the drain valve assembly 118 may be included in only one of the first filtration stage or the second filtration stage. In the embodiment of FIG. 8, the drain valve assembly 118 includes a drain line (see FIGS. 3-4) that fluidly couples a lower portion of the inner cavity 116, below the second endplate 114 (see FIG. 1), to the drain valve 119. The drain line also fluidly couples lower end of an outer annular portion of the inner cavity 116 to the drain valve 119. The filter assembly 101 also includes a water-in-fuel sensor 121 to control operation of the drain valve 119 when water is detected in the inner cavity 116 (e.g., to selectively open the drain valve 119 when water is detected, to drain the water from the inner cavity 116).

As shown in FIG. 8, the second endplate 114 defines at least one opening 122, positioned between the inner media pack 108 and the outer media pack 110, and that fluidly couples a space between the inner media pack 108 and the outer media pack 110 with the lower portion of the inner cavity 116 and drain valve assembly 118. The second endplate 114 includes a first portion 157 (e.g., outer portion) supporting the outer media pack 110 and a second portion 159 (e.g., inner portion) supporting the inner media pack 108. The first portion 157 includes a first pair of sidewalls 160 defining a first channel 162 that is sized to receive the outer media pack first end 125 therein. Similarly, the second portion 159 includes a second pair of sidewalls 164 defining a second channel 166 that is sized to receive an axial end of the inner media pack 108 therein. The outer media pack 110 and the inner media pack 108 are coupled to the second endplate 114 via a potting operating using an adhesive or curable urethane material that is disposed in the first channel 162 and the second channel 166, respectively.

As shown in FIG. 8, the second endplate 114 also includes a perforated extension 168 that extends between the first portion 157 and the second portion 159. The perforated extension 168 includes a plurality of legs 170 (e.g., supports, etc.) that extend at an angle between the first portion 157 and the second portion 159. A first (e.g., lower) end of each leg engages a flange that extends radially inward from the first portion 157 toward the second portion 159. A second (e.g., upper) end of each leg is coupled to a lower surface of the second portion 159. The legs 170 extend at least partially radially away from the first portion 157 and axially upwardly from the first portion 157 toward the second portion 159. In other embodiments, the shape, size, number, and/or position of the legs 170 may be different. In at least one embodiment, the legs 170 are integrally formed with the second portion 159 of the second endplate 114 as a unitary body such that the legs 170 cannot be separated from the second portion 159 without breaking the legs 170. In another embodiment, the legs 170 are integrally formed with the first portion 157. In the embodiment of FIG. 8, the legs 170 are not affixed to the first portion 157, but engage the flange to prevent axial movement of the inner media pack 108 with respect to the outer media pack 110. Among other benefits, separating the first portion 157 from the second portion 159 by the legs 170 facilitates assembly of the filter element assembly 103 because this structure allows the first portion 157 to be installed separately from the second portion 159. In other embodiments, the structure of the perforated extension 168 may be different. For example, the perforated extension 168 may include a conical plate that extends along the entire perimeter of the first portion 157 and the second portion 159. The plate may include a plurality of openings to allow water to drain from the annular gap between the inner media pack 108 and the outer media pack 110.

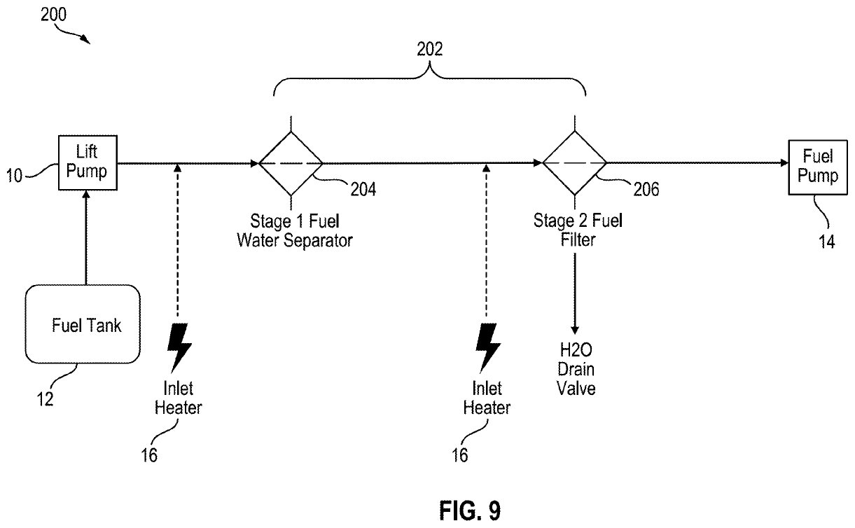

FIGS. 9-15 show a multiple stage (e.g., two stage) diesel fuel filtration system, shown as filtration system 200, according to an embodiment. As shown in FIG. 9, the filtration system 200 is configured to fluidly couple to a lift pump 10 (e.g., an in-tank pump, etc.), which is used to direct fuel from a fuel tank 12 toward a first stage 204 of a two stage filter assembly 202, and a fuel pump 14 (e.g., a low and/or high pressure pump), which is configured to direct fuel from a second stage 206 of the two stage filter assembly 202 to a fuel injection system of an internal combustion engine. Fuel leaving the lift pump 10 at elevated pressure (e.g., 7 bar) is passed to the first stage 204, then through an inlet heater 16 (e.g., an electric heater) disposed between the first stage 204 and the second stage 206, and from the second stage 206 to the fuel pump 14. The inlet heater 16 may be a direct current (DC) electric heater (e.g., a 12 V, 300 W heater), or another suitable fluid heater type/size. In other embodiments, the position of the inlet heater 16 may be different. For example, the inlet heater 16 may be disposed at an inlet to the first stage 204 rather than the second stage 206, to reduce the risk of fuel gelling within the first stage 204 during operation in cold weather conditions.

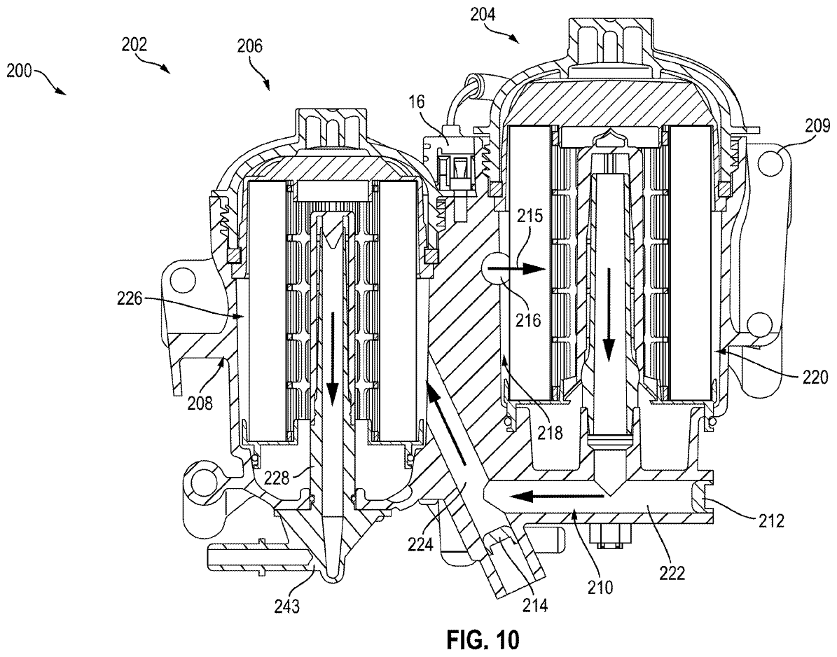

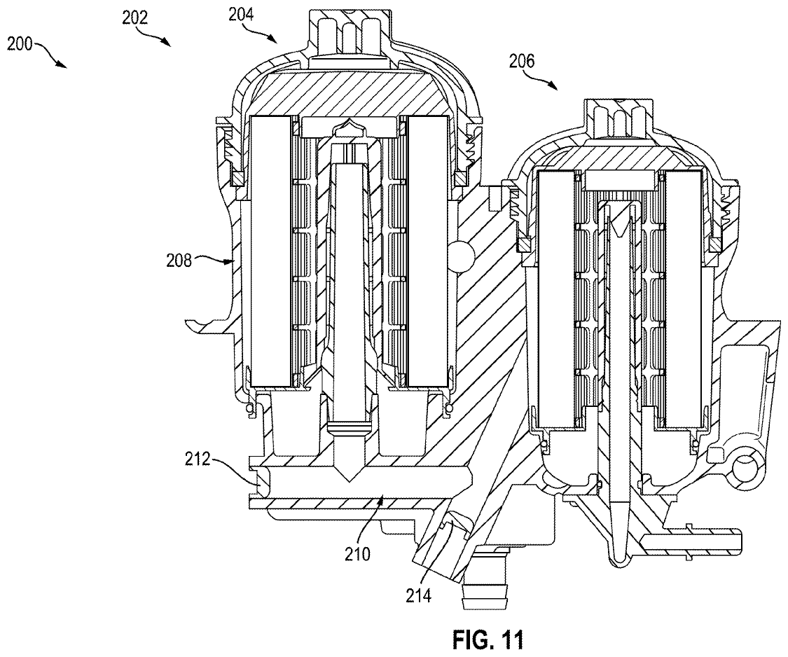

FIGS. 10-15 show various cross-sectional views of the two stage filter assembly 202 of FIG. 9, according to an embodiment. As shown, the two stage filter assembly 202 includes a filter housing 208 that is shared between the first stage 204 and the second stage 206. The filter housing 208 is integrally cast (e.g., die cast, etc.) or otherwise formed from a single piece of material. The filter housing 208 includes mounts 209 to facilitate installation of the two stage filter assembly 202 onto a vehicle chassis or engine. Among other benefits, this single housing construction provides a more compact design relative to using separate filter assemblies with separate housings (e.g., one for each stage of filtration). The two stage filter assembly 202 incorporates various components of the filtration system 200 into a single module. For example, as shown in FIGS. 10-11, the two stage filter assembly 202 includes an cross-flow conduit 210 that is integrated into the filter housing 208 and that fluidly couples the first stage 204 (e.g., a clean side of the first stage 204) and the second stage 206 (e.g., a dirty side of the second stage 206). The two stage filter assembly 202 also includes diagnostic ports 212, 214 that allow access to different flow legs (e.g., channel portions) of the cross-flow conduit 210. The diagnostic ports 212, 214 facilitate the installation of sensors (e.g., pressure sensors, temperature sensors, flow sensors, etc.) for monitoring the operation of the filtration system 200, or for maintenance purposes (e.g., to clean out and/or inspect the cross-flow conduit 210 for blockages).

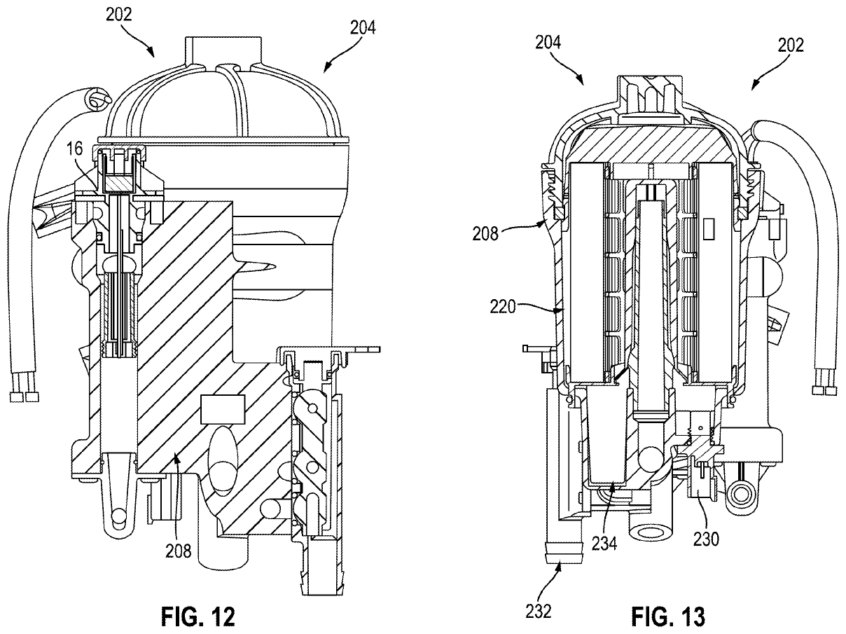

As shown in FIG. 12, the fluid is preheated before entering the first stage 204, via an inlet heater 16 (e.g., electric heater, stick heater) that is disposed between an inlet conduit (e.g., a quick connect inlet fitting) of the two stage filter assembly 202 and the inlet port 216 to the annular cavity 218 (see FIG. 10). The inlet heater 16 is detachably coupled to the filter housing 208 and may be removed from a port at the top of the filter housing 208 for maintenance and/or replacement. As indicated by the flow arrows 215 in FIG. 10, flow entering the two stage filter assembly 202 is introduced from an inlet port 216 to an annular cavity 218 on the dirty side of a first stage filter element assembly 220. The flow then passes through the first stage filter element assembly 220 and into a horizontal leg 222 of the cross-flow conduit 210. The clean fluid from the first stage 204 continues to a vertical leg 224 of the cross-flow conduit 210 and into a dirty side of the second stage 206. From there, the fluid passes through a second stage filter element assembly 226 and through a standpipe 228 to an outlet port and the rest of the filtration system 200. As shown for any of the above embodiments, the filter element for the second stage 206 may have an injection molded center post (e.g., upper portion of standpipe 228) with an integrated outlet quick-connect port/fitting 243 to ensure an optimum cleanliness level for fuel flowing out of the module. The center post may include a no filter no run (NFNR) ball feature to ensure a filter element is present within the filter assembly and to prevent fuel from being delivered to the engine system when a non-genuine filter element is placed into the filter assembly.

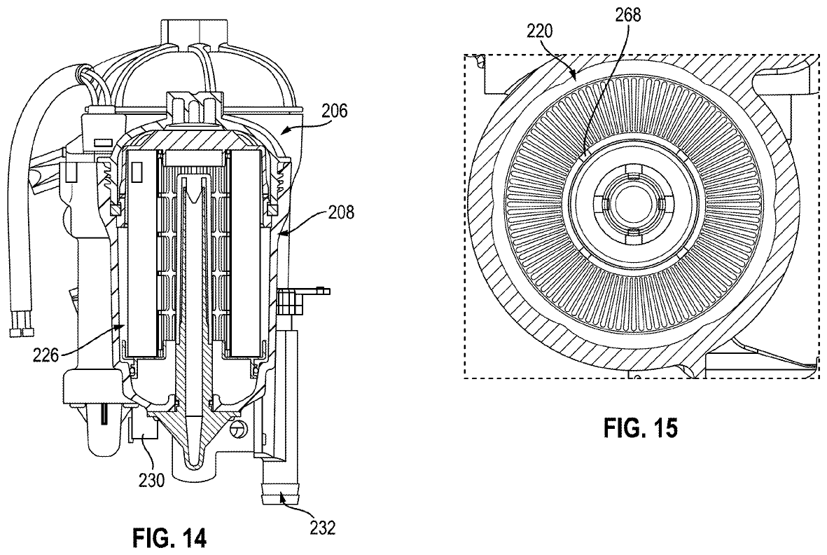

As shown in FIGS. 13-14, each of the first stage 204 and the second stage 206 include an integrated fuel collecting sump (e.g., cavity, etc.) below first stage filter element assembly 220 and the second stage filter element assembly 226, respectively, to collect water that has been separated by the first stage filter element assembly 220 or the second stage filter element assembly 226. As shown in FIG. 12, the filtration system 200 also includes at least one integrated water-in-fuel (WIF) sensor 230 to determine when water needs to be drained from the filter housing 208, through a drain valve assembly 232 that fluidly couples an inner cavity 234 of the filter housing 208 to an environment surrounding the two stage filter assembly 202. The structure of the drain valve assembly 232 may be the same or similar to the drain valve assembly 118 described with reference to FIGS. 1-5. For example, as shown in FIG. 15, any water that coalesces toward the lower end of the first stage filter element assembly 220 or that is separated downstream of the first stage filter element assembly 220 is directed through openings at the lower end (e.g., through a perforated extension 268 between an inner and outer portion of the first stage filter element assembly 220) to the fuel collecting sump and the drain valve assembly 232. In at least one embodiment, the drain valve assembly 232 is shared between each of the first stage 204 and the second stage 206. In other embodiments, each filter stage includes its own separate drain valve assembly 232.

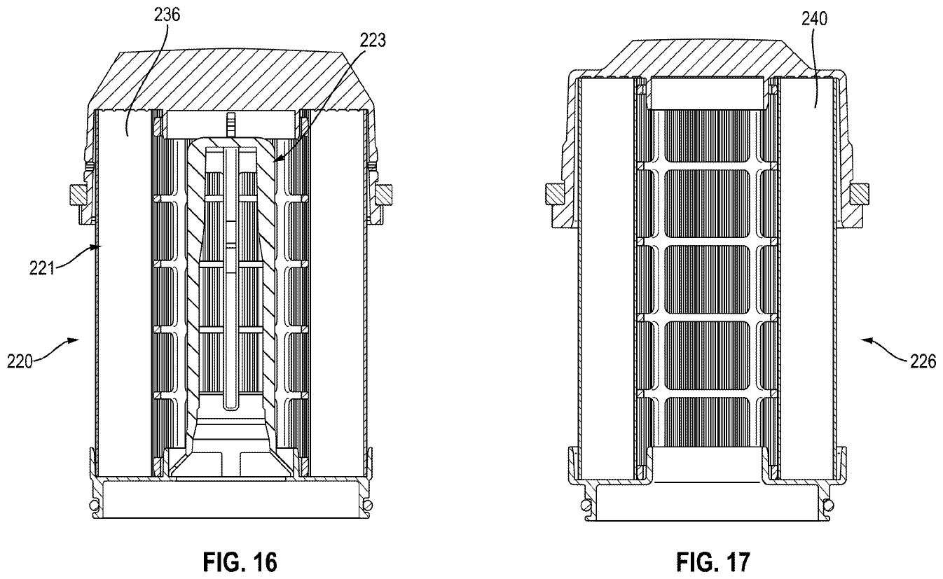

As with the filter assembly 101 described with reference to FIGS. 1-5, each stage of the filtration system 200 of FIGS. 9-15 includes a removable fuel filter element assembly (e.g., cartridge, etc.) and an interlocking seal mechanism that is formed at least partially by an endplate of the filter element assembly (e.g., a first endplate, an upper endplate, etc.). FIGS. 16-17 show side cross-sectional views of the first stage filter element assembly 220 and the second stage filter element assembly 226, respectively. The construction of each filter element assembly may be the same or similar to the construction of the filter element assembly 103 described with reference to FIG. 6. As shown in FIGS. 16-17, an outer portion 221 of the first stage filter element assembly 220 includes an outer media pack 236 and an inner portion 223. In at least one embodiment, the inner portion 223 includes a hydrophobic screen assembly. The second stage filter element assembly 226 includes an outer media pack 240 only. In other embodiments, the arrangement of the first stage filter element assembly 220 and the second stage filter element assembly 226 may be different.

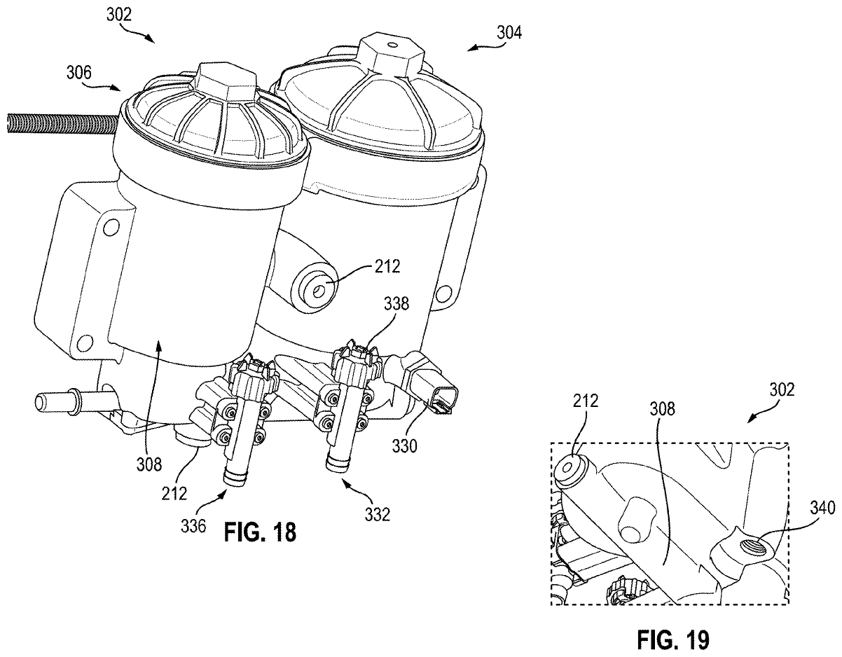

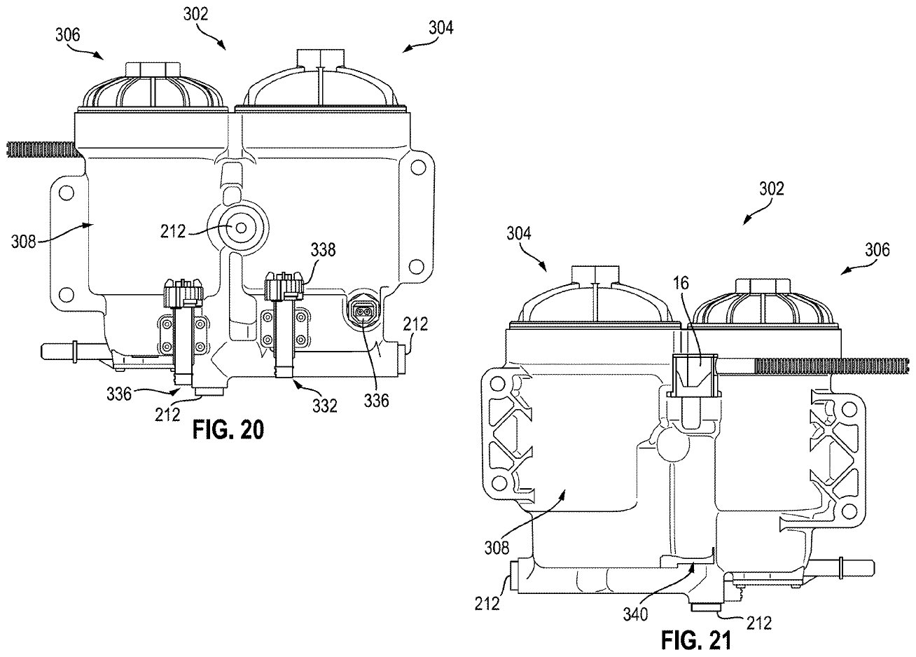

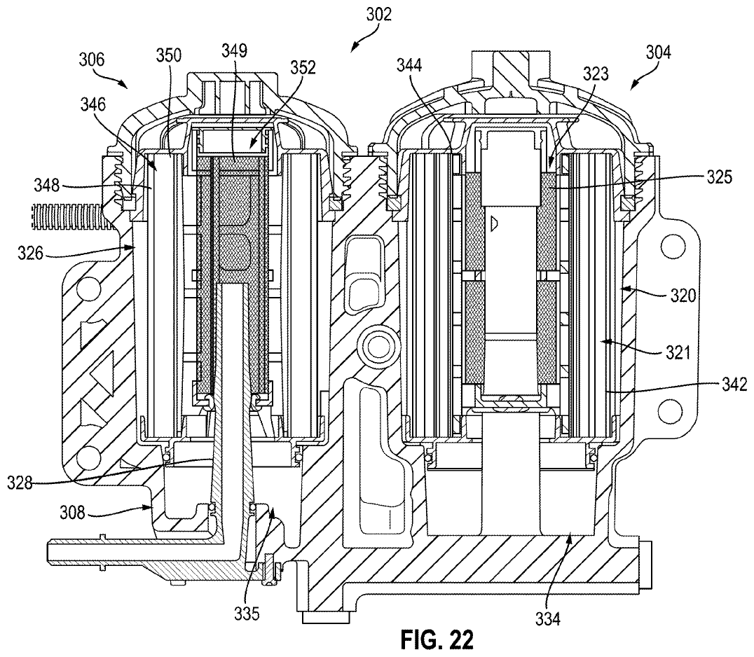

FIGS. 18-22 show a two stage filter assembly 302, according to another embodiment. The two stage filter assembly 302 includes a filter housing 308 that is shared between the first stage 304 and the second stage 306. As shown in FIGS. 18 and 20, the first stage 304 includes an integrated water-in-fuel (WIF) sensor 330 to determine when water needs to be drained from the filter housing 308, through a drain valve assembly 332 that fluidly couples an inner cavity (e.g., first inner cavity 334, second inner cavity 335) of the filter housing 308 to an environment surrounding the filter housing 308 (see also FIG. 22). In at least one embodiment, the second stage 306 also includes a WIF sensor. In the embodiment of FIGS. 18-22, the second stage 306 includes a drain valve assembly 336 that is separate from the drain valve assembly 332 of the first stage 304. Each drain valve assembly also includes an actuator 338 (e.g., a rotatable knob, etc.) that can be manually manipulated by a user to drain fluid from the water collection sump for each of the first stage 304 and the second stage 306.

As shown in FIGS. 19 and 21, an inlet fitting 340 for the two stage filter assembly 302 is integrally formed into a lower end (e.g., rear end) of the filter housing 308. The two stage filter assembly 302 also includes an inlet heater 16 (e.g., electric heater, stick heater, etc.) that is detachably coupled to the filter housing 308 via a port at a top end of the filter housing 308, in between the first stage 304 and the second stage 306. As shown in FIGS. 18-21, the two stage filter assembly 302 includes a plurality of diagnostic ports 212 (e.g., closed off with fittings) to facilitate maintenance, add sensors, or the like.

As shown in FIG. 22, each stage of the two stage filter assembly 302 includes a filter element assembly (e.g., cartridge such as a SmartLock cartridge, etc.) that is removable through a respective one of the lids for the first stage 304 and the second stage 306. An inner cavity for each of the first stage 304 and the second stage 306 is sealed from an environment surrounding the filter housing 308 by an interlocking seal mechanism that is formed, at least in part, by a sealing member disposed on a first endplate of each filter element assembly. The filter housing 308 may be a die cast aluminum housing, or made from another suitable material. The spin-on lids for each of the first stage 304 and the second stage 306 may be made from a composite material, plastic, or another suitable material. In at least one embodiment, the two stage filter assembly 302 may be operable without one of the two filter element assemblies. For example, the two stage filter assembly 302 may be used with the second stage filter element assembly 326 removed from the filter housing 308 to provide a single stage of filtration, without impacting the pressure drop across the two stage filter assembly 302 (e.g., with a reduced pressure drop across the second stage 306).

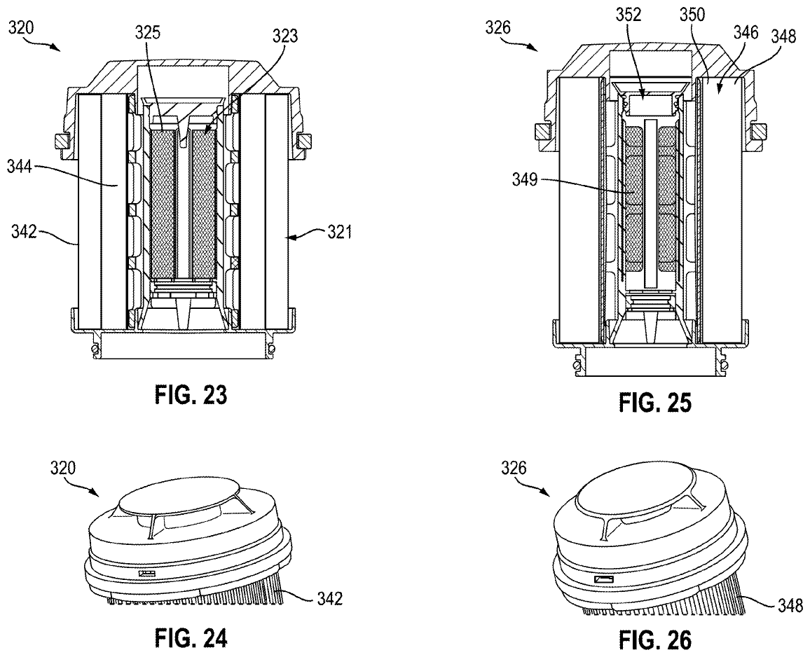

The construction of each filter element assembly may be the same or similar to the construction of the filter element assemblies described with reference to the embodiments of FIG. 1-5 or 10-15. As shown in FIGS. 22-24, an outer portion 321 of the first stage filter element assembly 320 includes a pleated media 342 and a coalescing wrap 344 that is nested within the pleated media 342, such that the pleated media 342 circumscribes the coalescing wrap 344. An inner portion 323 of the first stage filter element assembly 320 includes a hydrophobic screen 325 to separate any water from the fuel that is not removed via the coalescing wrap 344. As shown in FIGS. 22 and 25-26, the structure of the second stage filter element assembly 326 is similar to the first stage filter element assembly 320. Again, an outer portion 346 of the second stage filter element assembly 326 includes a pleated media 348 that and a coalescing wrap 350 nested within the pleated media 348. An inner portion 352 of the second stage filter element assembly 326 includes a hydrophobic screen 349. Water collected at the base of the coalescing wrap or that is separated by the hydrophobic screen for each of the first stage 304 and the second stage 306 is directed through openings in the second endplate (e.g., lower endplate) to a water collection sump at the base of the filter housing 308 for each of the first stage 304 and the second stage 306. In the embodiment of FIGS. 22-26, each of the first stage filter element assembly 320 and the second stage filter element assembly 326 are incinerable (e.g., made from non-metallic materials such as plastics, media, etc.).

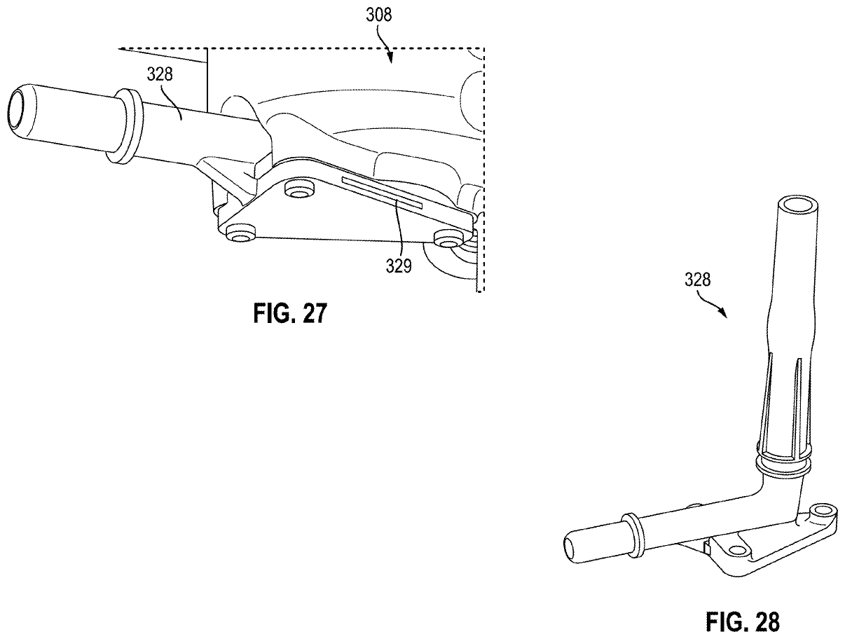

As shown in FIG. 22, clean fuel leaving the two stage filter assembly 302 is directed through a standpipe 328 that is disposed at least partially within an inner cavity for the second stage 306. The standpipe 328 is detachably coupled to the filter housing 308 and extends axially upwardly through an opening at the base of the second stage 306. FIGS. 27-28 show perspective and side views of the standpipe 328. As shown, the standpipe 328 is molded or otherwise formed from a single piece of material (e.g., nylon, etc.), which helps control cleanliness and reduces the need to have exceedingly clean module components upstream of the standpipe 328. In the embodiment of FIG. 27, the standpipe 328 includes a stabilizing plate 329 that is made from a metal or another suitable material to increase the strength of the standpipe 328 and the connection between the standpipe 328 and the filter housing 308. The stabilizing plate 329 may be molded into a base of the standpipe 328 or otherwise joined or engaged with the base to increase the strength of the standpipe 328 and connection.

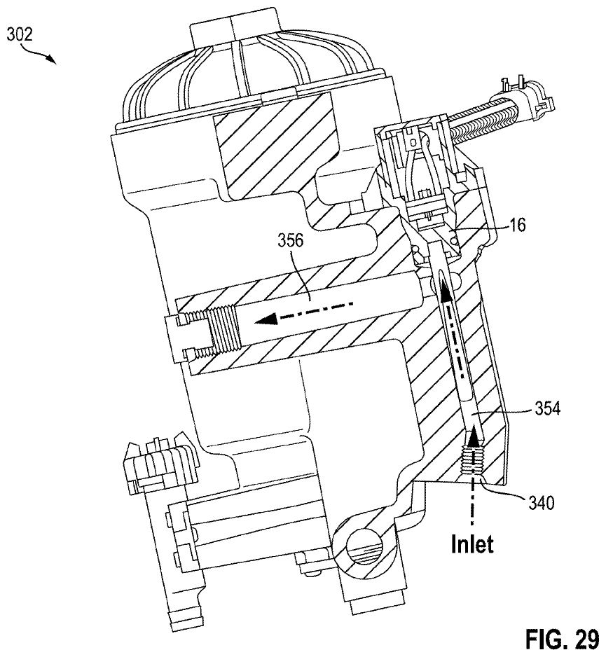

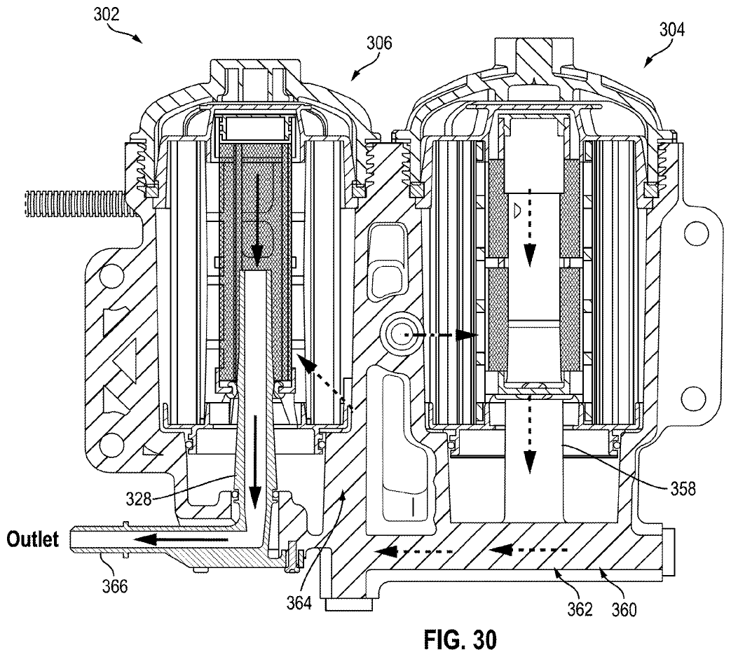

FIGS. 29-30 show the flow path through the two stage filter assembly 302. As shown, flow enters through the inlet fitting 340 and passes vertically through a first portion 354 (e.g., leg) of an inlet channel, which contains a heating element for the inlet heater 16, and horizontally through a second portion 356 of the inlet channel toward the first stage 304. Clean fluid leaving the first stage 304 passes through a center tube 358 in the first stage 304 and through a first leg 360 (e.g., horizontal leg) of a cross-flow channel 362 that extends between the first stage 304 and the second stage 306. Flow continues through a second leg 364 (e.g., vertical leg) of the cross-flow channel 362 and is introduced to a dirty side of the second stage 306. Clean fluid leaving the second stage 306 is directed, via the standpipe 328 to an outlet fitting 366 and the rest of the fuel filtration system.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed (e.g., within plus or minus five percent of a given angle or other value) are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the embodiments described herein.

While this specification contains many specific implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A filter element, comprising:
a media pack having a media pack first end and a media pack second end opposite the media pack first end;
a first endplate sealingly engaged with the media pack first end, the first endplate comprising a skirt extending along a longitudinal axis of the media pack from the media pack first end toward the media pack second end, wherein the skirt comprises an upper protrusion and a lower protrusion spaced axially apart from the upper protrusion, the upper protrusion and the lower protrusion together defining a recessed area, wherein an outer radius of the lower protrusion is greater than an outer radius of the upper protrusion;
a second endplate sealingly engaged with the media pack second end, the second endplate comprising an axial sidewall and an inner perimeter;
a first sealing member coupled to the axial sidewall and protruding radially outwardly from the axial sidewall; and
a second sealing member coupled to the second endplate and disposed radially inwardly from the inner perimeter.

2. The filter element of claim 1 wherein the media pack comprises an outer media pack defining a central cavity and an inner media pack disposed within the central cavity.

3. The filter element of claim 2, wherein the first endplate is coupled to both the outer media pack and the inner media pack.

4. The filter element of claim 3 wherein the first endplate comprises an outer portion sealingly engaging the outer media pack and an inner portion sealingly engaging the inner media pack.

5. The filter element of claim 4 wherein the inner portion comprises a projection extending along the longitudinal axis from an interior surface of the inner portion toward the second endplate.

6. A filter assembly comprising the filter element of claim 1, and further comprising a filter housing comprising:
a shell defining an inner cavity; and
a lid configured to engage the shell;
wherein the filter element is disposed within the inner cavity.

7. The filter assembly of claim 6 further comprising a third seal disposed between the lid and the shell.

8. The filter assembly of claim 7 wherein the third seal engages a radial surface of the skirt.

9. The filter assembly of claim 8 wherein the lower protrusion is disposed between an upper ledge defined by the shell and a lower edge defined by the lid, wherein the upper ledge and lower edge are longitudinally spaced.
